(19) United States
(12) Patent Application Publication
(10) Pub. No.: US 2023/0202222 A1
(43) Pub. Date: Jun. 29, 2023

(54) PROTECTIVE DOCUMENT COVER

(71) Applicant: Robert Eugene Napierala, II, Toledo, OH (US)

(72) Inventor: Robert Eugene Napierala, II, Toledo, OH (US)

(21) Appl. No.: 17/645,824

(22) Filed: Dec. 23, 2021

(51) Int. Cl. B42D 3/00; B42D 25/20; B42D 3/18

(52) U.S. Cl. CPC B42D 3/002; B42D 3/18; B42D 25/20; G09F 3/18

(57) ABSTRACT

A protective document cover is disclosed. The protective document cover includes a clear protective sheet that may be affixed to the front and/or back surface of a document, such as a vaccination card, via an adhesive. Micro-perforations in the sheet define one or more non-adhesive tear away covers that are dimensioned and positioned to overly updateable field(s) of the document to allow the tear away cover(s) to be removed from the protective cover and document and allow updating of the field(s) on the document. Removal of the tear away cover(s) allow a healthcare provider to record additional information to update the card. Pressure sensitive replacement covers, with permanent adhesive, of the same size as the tear away covers are provided to permanently protect the areas where additional information has been recorded. The protective replacement cover(s), once applied to the card provide permanent protection to the updated area of the card.

### BACKGROUND OF THE INVENTION

The present invention relates to document covers, and more particularly to document covers for documents with one or more updatable fields, such as a vaccination card.

Document covers are intended to protect the underlying document from deterioration or damage as the documents are referenced and utilized. Typically, a document will not need be modified at a subsequent time. In these instances, the document may be laminated to protect the document for multiple uses. An example may be a restaurant menu that is laminated to protect the menu from spillage of drinks, condiments, and foods. The laminated menu of this example may be cleaned and used for multiple diners.

For other documents, such as a vaccination card, the bearer of the document may need to present the vaccination card to obtain services or even entry to a location. The bearer of the vaccination card may also need to receive updates to their vaccinations over time. Accordingly, laminating the card may not be desirable or suitable.

Thus, existing document covers do not protect the document while the document is being removed from the cover, while out of the cover, or while being inserted into the cover. Likewise, existing document covers do not allow cards to be updated once a protective cover has been laminated to the card.

As can be seen, there is a need for improved document cover that protects the underlying document, but allows for updating of the underlying document over time.

### SUMMARY OF THE INVENTION

In one aspect of the present invention, a protective cover for a document is disclosed. The protective cover includes a sheet of clear protective material dimensioned to cover a document to be protected. The sheet of clear protective material has a front surface and a back surface. One or more tear away covers are defined by a micro perforation in the sheet of clear protective material. The one or more tear away covers are dimensioned and positioned on the sheet of clear protective material to overly an updatable field of the document when the protective cover is applied to the document. An adhesive layer secures the protective cover to both sides of the document and seals the edges.

In some embodiments, the adhesive layer is not applied to a back surface of the one or more tear away covers or has been deadened with an adhesive deadener. In other embodiments, the adhesive layer is selected to be releasable from a surface of the document to be protected.

In some embodiments, a silicone release liner covers the adhesive layer. A section of the silicone release liner may extend beyond a perimeter of the sheet of clear protective material. One or more replacement covers are releasably secured to the silicone release liner by the adhesive layer.

In some embodiments, a fold line is defined across an intermediate portion of the sheet of clear protective material. The fold line defines a front portion and an aft portion of the sheet of clear protective material.

In some embodiments, a score line is cut through the silicone release liner permitting selective removal of the silicone release liner from the front portion and the aft portion of the sheet of clear protective material.

In some embodiments, a cut line is defined at the leading edge of each of the one or more tear away covers, the cut line defining a pull tab for removal of the one or more tear away covers from the sheet of clear protective material.

In some embodiments, the document to be protected is a vaccination card, and the updateable field of the document is a field for recording information pertaining to a subsequent vaccination or booster shot.

In other aspects of the invention, a method of protecting a document having one or more updateable fields is disclosed. The method includes providing a document cover comprising a sheet of clear protective material dimensioned to cover a document to be protected, the sheet of clear protective material having a front surface and a back surface, an adhesive layer covering the back surface and one or more tear away covers defined by a micro perforation in the surface of the sheet of clear protective material. The one or more tear away covers are dimensioned and positioned on the sheet of clear protective material to overly an updatable field of the document when the protective cover is applied to the document. The method includes applying the adhesive back surface of the document cover to the document so that the one or more tear away covers overly the one or more updateable fields. In most embodiments, the tear away covers do not contain adhesive on the back side or the adhesive has been deadened with a printed adhesive deadener to allow the micro perforated portion of the protective cover to be cleanly removed over the updatable portion of the document. In other embodiments, the adhesive layer is selected to be releasable from a surface of the document to be protected.

In other embodiments, the method includes removing at least one of the one or more tear away covers from the document cover and the document. The method may also include updating at least one of the one or more updateable fields.

In other embodiments, the method includes applying a replacement cover(s) to at least one of the one or more areas where a tear away cover(s) has been removed from the document cover.

In yet other embodiments, the method includes removing a replacement cover from a silicone release liner, the replacement cover dimensioned to correspond with the one or more tear away covers and applying the replacement cover to the document to permanently cover the one or more updateable fields.

These and other features, aspects and advantages of the present invention will become better understood with reference to the following drawings, description and claims.

### BRIEF DESCRIPTION OF THE DRAWINGS

FIG. 1 is a perspective view of a protective document cover, shown in use.

FIG. 2 is a top view of the protective document cover.

FIG. 3 is a top exploded view of the protective document cover.

FIG. 4 is a bottom exploded view of the protective document cover.

FIG. 5 is a side view of the protective document cover, showing the first step installation with part of 42 removed.

FIG. 6 is a side view of the invention, showing a second step of installation of wrapping the aft portion of the protective cover over the back side of the document after the second part of the silicone release liner 42 has been removed.

FIG. 7 is a section view of the protective document cover taken along line 7-7 in FIG. 1.

FIG. 8 is a section view of the protective document cover taken along line 8-8 in FIG. 1.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a document cover that protects the document from marring, deterioration, or damage, while also providing provision for updating the underlying document over time.

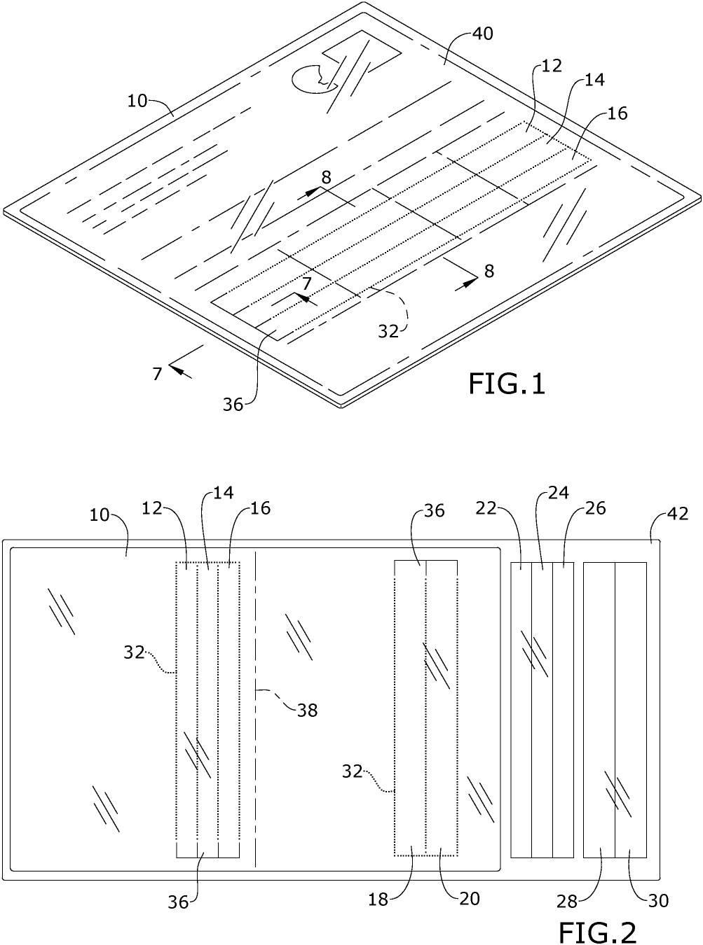

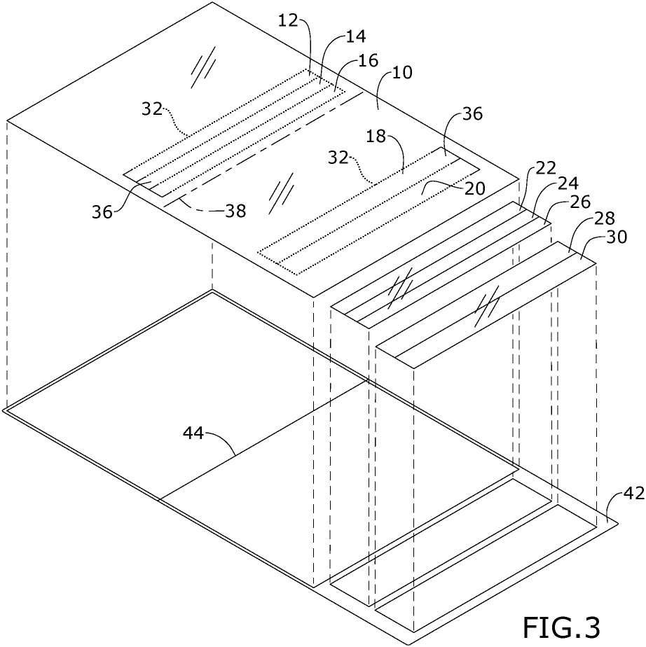

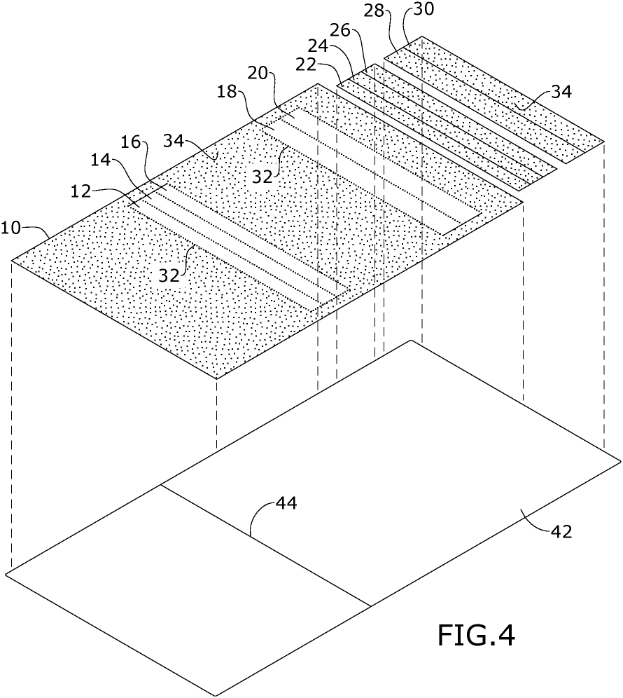

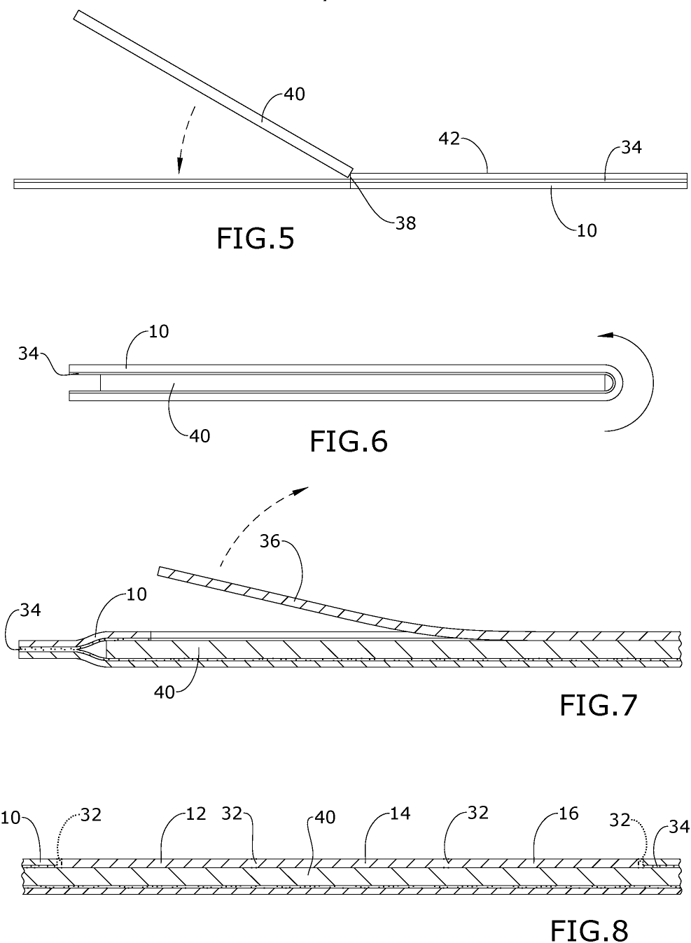

A document cover according to aspects of the present invention is shown in reference to the drawings of FIGS. 1-8. The document cover, once applied to the document, such as a vaccination card, provides protection all the time and allows the cards to be updated as future vaccinations are required. The document cover is made from a durable clear material that provides protection from wear and tear while allowing an owner to remove one or more protected areas to update their cards and then re-protect the area of the card that was updated with a permanent protective replacement cover.

The document cover 10 includes a sheet of clear protective material having a front surface and a back surface. The clear protective material is dimensioned to cover a document 40 to be protected. Preferably, the document cover 10 is applied so that it will protect each of a front surface and a back surface of the document 40. Accordingly, the document cover 10 may include a fold line 38 along which the sheet of clear protective material is folded. The back surface of the document cover 10 contains an adhesive layer 34 over all areas of the back of the cover 10 except the portion of the protective cover that contains one or more of the micro perforations so that those sections can be removed from the document 40.

A silicone release liner 42 is applied to the adhesive layer 34 until the document cover 10 is ready for use. The silicone release liner 42 may have a score or cut line 44 separating the silicone release liner at the bottom of the front portion of the document cover 10 from the bottom of the aft portion of the document cover 10. Preferably, the score line 44 corresponds with the fold line 38 in the document cover. The front portion of the document cover 10 is applied to a front surface of the document 40 and the aft portion of the document cover 10 is applied to a back surface of the document 40. The score line 44 permits removal of a corresponding portion of the silicone release liner 42 to permit alignment and placement a first side of the document 40 with the exposed adhesive 34. Once the first side of the document 40 has been placed on the adhesive layer 34, the remainder of the silicone release liner 42 is removed. The second side of the document cover 10 may then be folded over and applied to the second side of the document 40 and the document cover 10 secured to the second side of the document 40 with the adhesive layer 34.

The document cover 10 may include one or more tear away covers 12, 14, 16, 18, 20 defined by a micro perforation to define a perimeter of the one or more tear away covers 12, 14, 16, 18, 20. The one or more tear away covers 12, 14, 16, 18, 20 are dimensioned and positioned to overly an updatable field of the document 40. In the case of a vaccination card 40, the one or more updatable fields may include fields to contain, for example, an identification of a subsequent vaccination, a date, and administering agency. The one or more tear away covers 12, 14, 16, 18, 20 may include one or more tear away covers 12, 14, 16 on a front surface of the document 40 and one or more tear away covers 18, 20 for a back surface of the document 40. Each of the one or more tear away covers 12, 14, 16, 18, 20 may have a pull tab 36 defined by a cut line, rather than the micro perforation defining the one or more tear away covers 12, 14, 16, 18, 20. Removal of a selected tear away cover allows update of the document 40 with the subsequent information. In some instances, the selected tear away cover may be reapplied to the document 40, depending upon the nature of the selected adhesive 34. In other instances, a back surface of the tear away cover 12, 14, 16, 18, 20 will be adhesive free or adhesive deadened so that it is releasable from the document 40 to be protected.

In some embodiments, the release layer 42 may be dimensioned larger than the document cover 10. In this case, the extension of the release layer 42 may include one or more replacement covers 22, 24, 26, 28, 30. When a selected tear away cover 12, 14, 16, 18, 20 is removed from the document cover 10 for an update to the document 40, one of the replacement covers 22, 24, 26, 28, 30 may be applied to cover the updatable field of the document 40 after one of the tear away covers 12, 14, 16, 18, 20 have been removed for updating of the document 40.

It should be understood, of course, that the foregoing relates to exemplary embodiments of the invention and that modifications may be made without departing from the spirit and scope of the invention as set forth in the following claims.

What is claimed is:

1. A protective cover for a document, comprising:
a sheet of clear protective material dimensioned to cover the document to be protected, the sheet of clear protective material having a front surface and a back surface;
one or more tear away covers defined by a micro perforation in the sheet of clear protective material, the one or more tear away covers dimensioned and positioned on the sheet of clear protective material to overly an updatable field of the document when the protective cover is applied to the document; and
an adhesive layer covering the back surface and selected to adhere to a front and aft surface of the document.

2. The protective cover of claim 1, wherein the adhesive layer is not applied to a back surface or has been deadened on the back surface of the one or more tear away covers.

3. The protective cover of claim 1, wherein the adhesive layer is selected to be releasable from a surface of the document to be protected.

4. The protective cover of claim 1, further comprising:
a silicone release liner covering the adhesive layer.

5. The protective cover of claim 4, further comprising:
a section of the silicone release liner extends beyond a perimeter of the sheet of clear protective material; and
one or more replacement covers releasably secured to the silicone release liner by the adhesive layer.

6. The protective cover of claim 4, further comprising:
a fold line defined across an intermediate portion of the sheet of clear protective material, the fold line defining a front portion and an aft portion of the sheet of clear protective material.

7. The protective cover of claim 6, further comprising:
a score or a cut line defined through the silicone release liner permitting selective removal of the silicone release liner from each of the front portion and the aft portion of the sheet of clear protective material.

8. The protective cover of claim 1, further comprising:
a cut line defined at a leading end of each of the one or more tear away covers, the cut line defining a pull tab for removal of the one or more tear away covers from the sheet of clear protective material.

9. The protective cover of claim 1, wherein the document is a vaccination card, and the updateable field of the document is a field for recording information pertaining to a subsequent vaccination.

10. A method of protecting a document having one or more updateable fields, comprising:
providing a document cover comprising a sheet of clear protective material dimensioned to cover the document to be protected, the sheet of clear protective material having a front surface and a back surface, an adhesive layer covering the back surface and selected to adhere to the front surface and back surface of the document, and one or more tear away covers defined by a micro perforation in the front surface of the sheet of clear protective material, the one or more tear away covers dimensioned and positioned on the sheet of clear protective material to overly an updatable field of the document when the protective cover is applied to the document; and
applying the back surface of the document cover to the document so that the one or more tear away covers overly the one or more updateable fields.

11. The method of claim 10, further comprising:
removing at least one of the one or more tear away covers from the document cover and the document.

12. The method of claim 11 further comprising:
updating at least one of the one or more updateable fields.

13. The method of claim 12, further comprising:
removing a permanent replacement cover from a silicone release liner, the permanent replacement cover dimensioned to correspond with a specific tear away cover.

14. The method of claim 12, further comprising:
reapplying a permanent replacement cover to at least one of the one or more updateable fields.
